(19) United States
(12) Patent Application Publication
(10) Pub. No.: US 2025/0356762 A1
(43) Pub. Date: Nov. 20, 2025

(54) SYSTEMS AND METHODS FOR PROVIDING TRANSPORTATION CORRIDOR RECOMMENDATIONS

(71) Applicant: Honeywell International Inc., Charlotte, NC (US)

(72) Inventors: Nagaraj Pandurang Naik, Bangalore (IN); Suman Lata, Hyderabad (IN); Shobha Shivarudraiah, Bangalore (IN); Sandeep Chakraborty, Bangalore (IN)

(21) Appl. No.: 18/777,921

(22) Filed: Jul. 19, 2024

(30) Foreign Application Priority Data
May 17, 2024 (IN) 202411038764

(51) Int. Cl. G08G 5/00; B64D 43/00

(52) U.S. Cl. CPC G08G 5/50; B64D 43/00; G08G 5/21; G08G 5/34; G08G 5/55

(57) ABSTRACT

Embodiments of the present disclosure provide systems and methods for providing transportation corridor recommendations. In one embodiment, a method includes receiving, by one or more processors and from a transportation corridor database, a set of transportation corridors, receiving, by the one or more processors, vehicle configuration data for a vehicle, receiving, by the one or more processors, an indication of a trigger event, selecting, by the one or more processors, a subset of transportation corridors from the set of transportation corridors based at least in part on the vehicle configuration data and the trigger event, providing, via a user interface of the vehicle, one or more of a visual representation of the subset of transportation corridors and a visual representation of a recommendation of a transportation corridor of the subset, wherein the recommendation is based at least in part on an efficiency metric value for the transportation corridor.

### CROSS-REFERENCE TO RELATED APPLICATIONS

This application claims priority to and the benefit of foreign Indian Provisional Patent Application No. 202411038764, filed on May 17, 2024 with the Government of India Patent Office and entitled “SYSTEMS AND METHODS FOR PROVIDING TRANSPORTATION CORRIDOR RECOMMENDATIONS,” the contents of which are incorporated herein by reference in their entirety.

### TECHNICAL FIELD

Embodiments of the present disclosure generally relate to the field of transportation, and specifically to systems and methods for providing transportation corridor recommendations.

### BACKGROUND

Some vehicles may be configured to receive various types of navigational information, which may be utilized for control or routing purposes. For example, a crewed or uncrewed vehicle may receive routing information that provides a pathway, such as a transportation corridor, for the vehicle to travel along. In some instances, however, a vehicle may not be able to safely travel along a given transportation corridor. For example, some traffic, weather, and/or emergency conditions may present challenges associated with navigating along a given transportation corridor. In such examples, some conventional systems for managing vehicle routing information may involve manually interfacing or communicating with various systems or agencies to update or change vehicle routing information, which may present various inefficiencies and challenges that have negative impacts on transportation safety and operational efficiency.

### BRIEF SUMMARY

In accordance with a first aspect of the disclosure, a method is provided. In some embodiments, the method is executable by at least one computing device embodied in hardware, software, firmware, and/or any combination thereof as described herein. In some examples, the method may include receiving, by one or more processors and from a transportation corridor database, a set of transportation corridors; receiving, by the one or more processors, vehicle configuration data for a vehicle; receiving, by the one or more processors, an indication of a trigger event; selecting, by the one or more processors, a subset of transportation corridors from the set of transportation corridors based at least in part on (i) the vehicle configuration data and (ii) the trigger event; providing, via a user interface of the vehicle, one or more of: (a) a visual representation of the subset of transportation corridors and (b) a visual representation of a recommendation of a transportation corridor of the subset, wherein the recommendation is based at least in part on an efficiency metric value for the transportation corridor; receiving, via the user interface of the vehicle, an indication of a transportation corridor selection determined by an occupant of the vehicle; and causing transmission of, by the one or more processors and to an external computing device, the indication of the transportation corridor selection.

In some examples, the method may further include receiving, by the one or more processors, a signal indicative of a request from the occupant of the vehicle for the efficiency metric value; and providing, via the user interface of the vehicle, an indication of the efficiency metric value based at least in part on receiving the signal. In some examples, the signal is generated based at least in part on the occupant of the vehicle positioning a cursor over a visual representation of the transportation corridor of the subset.

In some examples, the method may further include providing, via the user interface of the vehicle, (i) the indication of the efficiency metric value for the transportation corridor and (ii) a second indication of a second efficiency metric value for a second transportation corridor of the subset of transportation corridors, wherein the transportation corridor selection is based at least in part on the occupant of the vehicle comparing the efficiency metric value and the second efficiency metric value. In some examples, the transportation corridor selection indicates that the occupant of the vehicle has selected the second transportation corridor.

In some examples, the transportation corridor selection indicates that the occupant of the vehicle has selected the transportation corridor. In some examples, the vehicle configuration data comprises one or more of: (i) vehicle size data, (ii) vehicle weight data, (iii) vehicle capability data, (iv) vehicle navigational data, and (v) vehicle type data. In some examples, the trigger event comprises receiving one or more of: (i) weather data, (ii) traffic data, (iii) flight management system (FMS) data, and (iv) vehicle status data. In some examples, the set of transportation corridors comprises a plurality of transportation corridors below a threshold altitude.

In some examples, the set of transportation corridors comprises a plurality of transportation corridors for vertical takeoff and landing (VTOL) vehicles. In some examples, the method may further include communicating one or more control signals to one or more control systems of the vehicle based at least in part on the transportation corridor selection, wherein the one or more control signals cause the vehicle to switch from an initial transportation corridor to a selected transportation corridor.

In accordance with a second aspect of the disclosure, an apparatus is provided. In one example embodiment of the apparatus, the apparatus includes one or more processors and a memory storing instructions that, when executed by the one or more processors, cause the apparatus to perform any one of the methods described herein. A second example apparatus includes means for performing each step of any one of the methods described herein.

In accordance with a third aspect of the disclosure, a system is provided. In one example embodiment of the system, the system includes a user interface and one or more processors in communication with the user interface, wherein the one or more processors are configured to perform any one of the methods described herein. In one example embodiment of the system, an example system includes at least one non-transitory computer-readable storage medium having computer program code stored thereon that, in combination with one or more processors, is configured for performing any one of the example methods described herein.

### BRIEF DESCRIPTION OF THE DRAWINGS

FIG. 1 illustrates a system for providing transportation corridor recommendations in accordance with at least some embodiments of the present disclosure.

FIG. 2 illustrates a block diagram of a computing device for providing transportation corridor recommendations in accordance with at least some embodiments of the present disclosure.

FIG. 3 is a dataflow diagram showing example data structures and modules for providing transportation corridor recommendations in accordance with at least some embodiments of the present disclosure.

FIG. 4 is an operational example of a flowchart that supports providing transportation corridor recommendations in accordance with at least some embodiments of the present disclosure.

FIG. 5 is an operational example of a process that supports providing transportation corridor recommendations in accordance with at least some embodiments of the present disclosure.

FIG. 6 is an operational example of a communication diagram that supports providing transportation corridor recommendations in accordance with at least some embodiments of the present disclosure.

FIG. 7 is an operational example of a user interface display that supports providing transportation corridor recommendations in accordance with at least some embodiments of the present disclosure.

FIG. 8 is an operational example of a user interface display that supports providing transportation corridor recommendations in accordance with at least some embodiments of the present disclosure.

FIG. 9 illustrates a process for providing transportation corridor recommendations in accordance with at least some embodiments of the present disclosure.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

As described herein, some transportation systems may utilize transportation corridors to maintain separation and avoid collisions between vehicles. In some examples, transportation corridors may be categorized or otherwise grouped for specific types of vehicles. For example, transportation corridors may be utilized to provide a mechanism of separation between electric vertical takeoff and landing (eVTOL) vehicles and other types of aircraft. Within transportation corridors, separation may be maintained by various operators and/or individuals. For example, in an eVTOL context, an urban airspace service provider (UASP) may perform one or more actions to maintain separation between eVTOLs and other vehicles. In some examples, a transportation corridor may have or otherwise be associated with one or more performance requirements, such as one or more maneuverability performance requirements and/or one or more sense-and-avoid performance requirements, which may ensure efficient operations. As described herein, transportation corridors may enable existing traffic (e.g., non-eVTOL vehicles) to coexist safely with eVTOL vehicles while maximizing the capacity of urban airspace.

In some examples, a vehicle may switch from a first transportation corridor to a second transportation corridor. For example, an eVTOL may switch from a first transportation corridor to a second transportation corridor in response to a traffic-based condition, a weather condition, and/or an emergency. In such examples, the second transportation corridor or a request to switch to the second transportation corridor may be provided to the eVTOL. However, failure to switch to the second transportation corridor may lead to non-compliance with one or more urban air mobility (UAM) airspace procedures. The dynamic management of routes, transportation corridors, and airspace is the key for UASP operations. The primary goal of UASP flow management is to optimize airspace capacity, maintain a safe operating environment, and minimize congestion while traffic demand fluctuates over the course of the day. To achieve this goal, time-based metering could be used to regulate traffic flow and to strategically deconflict aircraft along routes. Automation could also be used to monitor congestion and capacity along routes and transportation corridors to maintain a steady flow of eVTOL aircrafts.

During emergency situations, dynamic airspace management becomes a critical service. Even though an UASP may be capable of providing emergency notifications, such notifications do not provide a pilot and/or operator with recommendations for alternative transportation corridors. In accordance with techniques described herein, a recommendation for a contingency decision (e.g., a recommendation for one or more transportation corridors to switch to) may be provided (e.g., in an ownship view) based on one or more onboard sensors. Such a recommendation may improve a confidence level of a pilot to fly to a new corridor. Accordingly, the techniques described herein provide a mechanism that will assist pilots in selecting one or more transportation corridors during emergency situations.

In some examples, a system may be provided that continuously and/or periodically monitors the state of a vehicle and identifiers any non-normal and/or emergency situation. A method may then be performed that assists one or more individuals (e.g., a pilot and/or crew members) in selecting one or more transportation corridors. In some examples, the techniques described herein may enable one or more individuals to select an optimal transportation corridor from a set or subset of transportation corridors. In some examples (e.g., based on one or more criteria being met and/or one or more trigger events), a set of potential transportation corridors that are applicable to the host vehicle may be analyzed. The analysis may be based on the vehicle size, vehicle weight, vehicle configuration, current weather conditions, current traffic conditions, and/or a transportation corridor database.

One or more of the analyzed transportation corridors (e.g., applicable transportation corridors) may then be presented to the crew for selection. In some examples, a particular transportation corridor may be determined to be the most efficient for the host vehicle. In such examples, the particular transportation corridor may be highlighted or otherwise emphasized on a user interface. For example, the user interface may display one or more transportation corridors including the particular transportation corridor with highlighting or emphasis applied to the particular transportation corridor. The highlighting and/or emphasis may indicate to one or more individuals (e.g., to a pilot and/or crew members) that the particular transportation corridor is recommended and/or a most efficient transportation corridor when compared to one or more other transportation corridors. In some examples, one or more individuals (e.g., a pilot and/or crew members) may select a transportation corridor, such as the highlighted transportation corridor, and communicate the selected transportation corridor to one or more other individuals (e.g., ground crew members), systems (e.g., ground-based systems), or institutions, such as the UASP via the available communication media.

For each applicable transportation corridor, an information box may be displayed to provide the crew with information corresponding to the respective transportation corridor. The information may include corridor width, passing zone distance, distance to refueling station, distance to vertiport, one or more efficiency metrics, and/or the like. The techniques of the present disclosure provide a myriad of technical advantages when compared to conventional techniques. For example, the techniques of the present disclosure enable one or more vehicle occupants (e.g., a pilot), to select a transportation corridor based on an emergency and a vehicle configuration. The techniques described herein may also ensure that an on-board system is in loop for the transportation corridor selection process and that the process is not completely dependent on the ground-based UASP communication. Additionally, in a scenario where a UASP is asking the UAM to fly to a new transportation corridor due to an emergency, the techniques described herein may validate that a provided transportation corridor is the right one for the vehicle.

### Overview

Some vehicles may be configured to receive various types of navigational information, which may be utilized for control or routing purposes. For example, a crewed or uncrewed vehicle may receive routing information that provides a pathway, such as a transportation corridor, for the vehicle to travel along. In some instances, however, a vehicle may not be able to safely travel along a given transportation corridor. For example, some traffic, weather, and/or emergency conditions may present challenges associated with navigating along a given transportation corridor. In such examples, some conventional systems for managing vehicle routing information may involve manually interfacing or communicating with various systems or agencies to update or change vehicle routing information, which may present various inefficiencies and challenges that have negative impacts on transportation safety and operational efficiency.

In accordance with one or more examples described herein, the techniques of the present disclosure enable the automatic recommendation of one or more transportation corridors based on various conditions and/or information, such as vehicle configuration data and the occurrence of one or more trigger events. For example, a computing device may continuously monitor for the occurrence of one or more trigger events, and, upon determining that the one or more trigger events has occurred, may provide one or more transportation corridor recommendations to a pilot of a vehicle. As described herein, such techniques may provide improved operational efficiency and transportation safety when compared to conventional techniques. For example, the techniques described herein may enable a pilot to select an optimal transportation corridor without manually requesting a transportation corridor update or otherwise manually engaging in communications with one or more other individuals. In some examples, the computing device may receive an indication of a selected transportation corridor from the pilot and cause one or more operations to be performed that result in the vehicle being navigated to or otherwise routed along the selected transportation corridor, which may improve vehicle safety.

The techniques described herein may also provide a vehicle and/or a pilot of a vehicle with an automated mechanism for communicating navigational updates to one or more other individuals, such as a member of a ground crew. For example, a computing device of a vehicle may receive a transportation corridor selection from the pilot and may automatically communicate the transportation corridor selection to one or more other computing devices. Such techniques may then enable one or more other individuals to perform one or more actions without manually communicating with the pilot. For example, a member of a ground crew may receive an indication of a transportation corridor selection and review or validate the selection, initiate one or more emergency preparedness actions, and/or initiate communications or transportation corridor updates for one or more other vehicles. In conventional systems, however, such transportation corridor updates may not be communicated or may not be communicated efficiently, which may present various safety hazards and operational inefficiencies.

In some examples, the techniques described herein may include providing a pilot with various recommendation insights that increase recommendation trustworthiness and improve pilot confidence. For example, the described techniques may include providing one or more transportation corridors recommendations in addition to information utilized to determine the recommendation. Such information may include one or more efficiency metric values, such as a distance to a nearest fueling station located along or within a threshold distance of the transportation corridor. Accordingly, when compared to conventional techniques, a pilot may be able to more efficiently and effectively evaluate two or more transportation corridor options, which may improve pilot decision making, recommendation trustworthiness, and transportation safety.

### Definitions

In some embodiments, the term “vehicle” refers to a mobile object or machine configured to travel or move from one location to another location. A vehicle may be propelled by one or more propulsions systems, such as one or more engines, one or more motors, and/or the like. In some examples, a vehicle may transport a payload including one or more objects and/or one or more individuals. A vehicle may be equipped with one or more control systems, such as a computing device, which may be configured to control the movement of the vehicle by communicating one or more control signals to one or more propulsion systems of the vehicle and/or one or more systems configured to steer, orient, or otherwise maneuver the vehicle. In some examples, a vehicle and/or a control system of a vehicle may be controlled by or may receive one or more inputs from one or more individuals, such as one or more pilots or drivers. In some other examples, a vehicle may be autonomous or unmanned. As described herein, a vehicle may be an aircraft, a spacecraft, a satellite, an automobile, a maritime vessel, an unmanned cargo vehicle utilized for package delivery, such as within a fulfilment or manufacturing system, and/or the like.

A vehicle may be equipped with one or more systems, such as one or more computing devices (e.g., one or more client devices of a server). In some examples, a vehicle may communicate with one or more other vehicles via a wireless network. For example, a computing device of a vehicle may include communication circuitry, which may enable the vehicle to wirelessly communicate with one or more other vehicles and/or one or more other data source systems. In some examples, a vehicle may be a vertical takeoff and landing (VTOL) vehicle and/or an electric VTOL (eVTOL).

In some embodiments, the term “transportation corridor” refers to a pathway, route, or portion of an environment where one or more vehicles are configured to or otherwise permitted to travel. In some examples, a transportation corridor may be a three-dimensional pathway, which may be mapped using one or more coordinates and/or one or more trajectories (e.g., straight lines and/or curved lines). In some examples, a transportation corridor may be a region of space. For example, a transportation corridor may be a region of space between an upper altitude boundary and a lower altitude boundary. In some examples, a vehicle may receive one or more indications of one or more transportation corridors or otherwise be configured to operate within one or more transportation corridors.

In some examples, transportation corridors may provide a mechanism of separation between various vehicles and/or types of vehicles. For example, transportation corridors may be utilized by VTOL vehicles to maintain separation between VTOL vehicles and other types of aircraft. Within transportation corridors, separation is maintained by vehicle operators, such as UASPs. Each transportation corridor may be associated with one or more performance requirements such as maneuverability requirements or sense-and-avoid requirements to ensure more efficient operations. For example, a transportation corridor that is near or intersects with a region having a relatively high volume of traffic when compared to other transportation corridors may have a more stringent sense-and-avoid requirement when compared to the other transportation corridors. In some examples, transportation corridors may enable existing traffic to coexist safely with eVTOL vehicles while maximizing the capacity of urban airspace.

In some embodiments, the term “transportation corridor database” refers to an information repository or storage location for storing information associated with one or more transportation corridors. For example, a transportation corridor database may store a plurality of data entries. Each data entry may include information associated with a respective transportation corridor. For example, a data entry may include an identifier for a transportation corridor (e.g., a name, an identification string), one or more geographic identifiers (e.g., waypoints, coordinates) for the transportation corridor, and/or one or more rules (e.g., performance requirements, vehicle configuration requirements) that specify one or more vehicle types and/or criteria for using the transportation corridor. In some examples, a transportation corridor database may include one or more transportation corridors for one or more specific types of vehicles. For example, a transportation corridor database may include a plurality of transportation corridors for VTOL vehicles.

In some examples, one or more processors (e.g., of a vehicle, of a computing device associated with a vehicle) may receive one or more transportation corridors (e.g., an indication of one or more transportation corridors, one or more identifiers for one or more transportation corridors, and/or the like) from a transportation corridor database. Additionally, or alternatively, the one or more processors may receive information associated with the one or more transportation corridors from the transportation corridor database. In some examples, the one or more transportation corridors and/or the information associated with the one or more transportation corridors may be received from a computing device that stores the transportation corridor database (e.g., a ground-based computing device). In some examples, one or more processors may receive a list or a set of all available transportation corridors from the transportation corridor database. In some examples, the list or the set may include all available transportation corridors for a specific vehicle type, such as all VTOL transportation corridors.

In some embodiments, the term “vehicle configuration data” refers to information indicative of one or more configurations, capabilities, and/or characteristics of a vehicle. In some examples, vehicle configuration data may be utilized to determine if one or more transportation corridors are appropriate, viable, or permitted for use by a specific vehicle. As described herein, some non-limiting examples of vehicle configuration data may include vehicle size data, vehicle weight data, vehicle capability data, vehicle navigational data, vehicle type data, and/or the like. Accordingly, one or more transportation corridors may be selected (e.g., by one or more processors) for use by a vehicle based on one or more types of vehicle configuration data. For example, a transportation corridor may be selected or otherwise determined to be appropriate for use by a given vehicle if a weight of the vehicle is below a threshold weight.

In some examples, one or more processors may perform one or more operations to select or otherwise generate a subset of transportation corridors based on vehicle configuration data for a vehicle. For example, the one or more processors may select the subset of transportation corridors from a set of all available transportation corridors provided by a transportation corridor database. Accordingly, the one or more processors may determine the subset of transportation corridors for providing to a specific vehicle or one or more individuals associated with the specific vehicle (e.g., a pilot of the specific vehicle, one or more air-based or ground-based crew members for the specific vehicle). By doing so, the specific vehicle may avoid utilizing transportation corridors that are not appropriate for the specific vehicle. Additionally, or alternatively, the one or more individuals associated with the specific vehicle may avoid unnecessarily reviewing transportation corridors that are not appropriate for the specific vehicle, which may result in improved operational efficiency and improved vehicle safety.

In some embodiments, the term “trigger event” refers to an event that prompts or causes the occurrence of one or more actions, operations, or other events. For example, one or more processors may select a subset of transportation corridors based on a trigger event (e.g., based on the occurrence of the trigger event, based on receiving an indication that a trigger event has occurred). In some examples, one or more processors may periodically and/or continuously monitor for the occurrence of a trigger event (e.g., a change in a state of a vehicle, receipt of an emergency alert, and/or the like). As described herein, some non-limiting examples of trigger events may include weather events, traffic-related events, flight management system (FMS) events, and/or vehicle status events. Additionally, or alternatively, the receipt of a message or information indicating the occurrence of a trigger event may itself be an example of a trigger event. For example, a trigger event may include receiving weather data, receiving traffic data, receiving FMS data, receiving vehicle status data, and/or the like. In some examples, a trigger event may include receiving specific types of data or specific data values (e.g., data values indicative of a specific condition). For example, receiving a message indicating wind speeds in a specific region greater than or equal to a wind speed threshold may be a trigger event.

In some embodiments, the term “user interface” refers to hardware and/or software that is configured to interface with one or more individuals. For example, a user interface may be a device that receives one or more inputs from a user and/or provides one or more outputs to the user, such as a monitor, a display, a speaker, a microphone, a printer, a keyboard, a mouse, a joystick, and/or the like. In some examples, a user interface may be a software application, such as a graphical user interface that is displayed and/or executed on a computing device. In some examples, a user interface may provide an audio and/or visual representation of information. For example, a user interface of a vehicle, such as a display of a flight management system or any other computing device associated with a vehicle, may provide a representation of one or more transportation corridors (e.g., a subset of transportation corridors) and/or a visual representation of a recommendation (e.g., a recommended transportation corridor of the subset). For example, a display screen in an aircraft may display a plurality of shapes (e.g., lines, pathways, and/or the like) representative of a plurality of transportation corridors. In some examples, a single shape of the plurality of shapes may be highlighted or displayed in a specific color, which may be representative of a recommendation of a single transportation corridor of one or more potential transportation corridors (e.g., the subset of transportation corridors).

In some embodiments, the term “visual representation” refers to a depiction or image that is displayed or otherwise provided to one or more individuals. For example, a user interface of a computing device may display a visual representation. As described herein, a visual representation may depict one or more transportation corridors. Additionally, or alternatively, a visual representation may include one or more features that emphasize or otherwise highlight a specific portion of the visual representation. For example, a visual representation of a transportation corridor may include highlighting indicating a recommendation associated with a portion of the visual representation (e.g., the highlighting may emphasize a specific transportation corridor of a subset of transportation corridors). Although various examples of the techniques described herein refer to visual representations, audio representations may also be utilized to emphasize or call attention to various features or aspects. For example, an audio notification (e.g., an audio message) may be provided to one or more individuals via one or more speakers. In some examples, an audio notification may describe or otherwise indicate a recommendation of one or more transportation corridors of a subset of transportation corridors.

In some embodiments, the term “efficiency metric value” refers to a value that represents one or more efficiency metrics associated with a vehicle. For example, an efficiency metric value may include a fuel consumption value, a power consumption value, a distance value, a time value, a speed value, and/or any other value that may be used by one or more individuals to determine an optimal transportation corridor for selection. In some examples, an efficiency metric value may be a composite value that aggregates or otherwise combines two or more efficiency metric values. As described herein, an efficiency metric value may be associated with a transportation corridor. For example, an efficiency metric value may represent an efficiency associated with a vehicle traveling from a start point to an end point via a transportation corridor. Accordingly, a user interface may indicate one or more efficiency metric values (or a composite efficiency metric value) for each transportation corridor that is available or displayed. In some examples, a user interface may display one or more efficiency metric values (or a composite efficiency metric value) in response to an individual (e.g., a user) placing a cursor over a specific region, such as a region including a representation of a specific transportation corridor. In some examples, a user interface may display the one or more efficiency metric values (or the composite efficiency metric value) in response to an individual selecting a corresponding transportation corridor (e.g., by pressing a corresponding button on a user interface and/or by pressing a portion of a touchscreen display).

In some embodiments, the term “transportation corridor selection” refers to one or more transportation corridors that are selected by one or more individuals. For example, a transportation corridor selection may include a transportation corridor that is selected by a pilot of an aircraft. In some examples, one or more individuals may select a transportation corridor by providing one or more inputs to a user interface. For example, a pilot of an aircraft may press a button or select a selectable shape displayed via a user interface to select a transportation corridor. In some examples, a transportation corridor selection may be communicated to one or more individuals and/or computing devices. For example, a pilot may select a transportation corridor and the transportation corridor selection may be communicated to one or more members of a ground crew. Automatically communicating the transportation corridor selection to the ground crew may enable the ground crew to make more informed decisions when compared to conventional systems where pilot decisions may not be communicated to a ground crew, or where relatively slower manual communications may reduce operational efficiency.

In some embodiments, the term “occupant of a vehicle” refers to an individual aboard a vehicle, such as a pilot, a crew member, or a passenger. In some examples, one or more occupants of a vehicle may participate in a decision making process for routing or otherwise controlling the vehicle. For example, one or more occupants of a vehicle may determine or select one or more transportation corridors for the vehicle. In some examples, the one or more occupants may determine or select the one or more transportation corridors for the vehicle from a subset of transportation corridors provided to the one or more occupants by a user interface of the vehicle. In some examples, the one or more occupants may determine or select the one or more transportation corridors based on one or more recommendations indicating one or more optimal transportation corridors (e.g., based on one or more efficiency metric values). As described herein, the one or more occupants may include a pilot, and/or one or more other occupants of a vehicle, such as in a scenario where the pilot is incapacitated.

In some embodiments, the term “external computing device” refers to a computing device that is external to a vehicle. For example, an external computing device may be a ground-based computing device and/or a computing device that is operated by a ground crew. As described herein, a computing device and/or entity (e.g., a cloud-based computing entity) associated with a vehicle (e.g., one or more processors of the computing device) may cause transmission of an indication of a transportation corridor selection to one or more external computing devices.

In some embodiments, the term “cursor” refers to an indicator, pointer, or marker that is viewable via a user interface and/or display. In some examples, a cursor may be generated by a computing device. The computing device may receive input from a user (e.g., via a touchscreen display, via a mouse, via a joystick) that facilitates movement of the cursor on the user interface and/or display. In some examples, one or more individuals may position a cursor to facilitate or otherwise cause one or more operations to be performed. For example, placing a cursor in a specific location (e.g., over an icon, over a shape indicative of a transportation corridor) may cause one or more operations to be performed, such as the display of one or more types of information (e.g., efficiency information, one or more efficiency metric values). In some examples, placing the cursor in the specific location and pressing one or more buttons may cause the one or more operations to be performed (e.g., clicking a button on a mouse).

In some embodiments, the term “threshold altitude” refers to a value that is an upper or lower bound. For example, some vehicles may be configured to operate at or below a threshold altitude of 10,000 feet. As described herein, various types of vehicles may be associated with various threshold altitudes for operation. Additionally, or alternatively, various transportation corridors may be associated with one or more threshold altitudes. For example, one or more processors may receive a set of transportation corridors for VTOL vehicles. Accordingly, the set of transportation corridors may include transportation corridors below a threshold altitude, such as 10,000 feet.

### Example Systems and Processes of the Disclosure

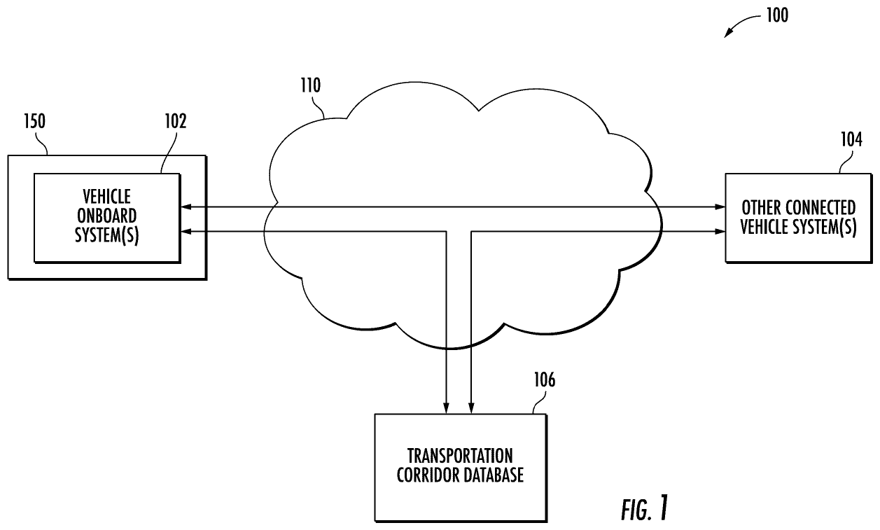

FIG. 1 illustrates a system for providing transportation corridor recommendations in accordance with one or more embodiments of the present disclosure. Specifically, FIG. 1 depicts an example system 100 within which embodiments of the present disclosure may operate to perform the techniques described herein. As depicted, the system 100 includes one or more vehicle onboard systems 102, for example, which embody one or more systems of a vehicle 150. In some embodiments, the one or more vehicle onboard systems 102 are optionally communicable with one or more other computing devices and/or systems, such as one or more other connected vehicle systems 104 (e.g., one or more onboard systems of one or more other vehicles, one or more ground-based systems, one or more cloud-based systems). In some embodiments, the one or more vehicle onboard systems 102 are communicable with one or more other connected vehicle systems 104 over one or more communication networks, such as the communications network 110.

In some embodiments, the one or more vehicle onboard systems 102 include any number of computing devices, entities, and/or systems embodied in hardware, software, firmware, and/or a combination thereof that control, operate, and/or are onboard a vehicle 150. In some examples, the one or more vehicle onboard systems may include one or more physical components of the vehicle 150, including and without limitation one or more computing devices, one or more displays, one or more flight management systems, one or more engines, one or more wings, one or more props, one or more motors, one or more antennas, one or more landing gear assemblies, and/or the like. In some embodiments, the one or more vehicle onboard systems 102 include one or more sensors (e.g., one or more cameras, one or more sensors of a camera) that gather, collect, and/or otherwise aggregate flight sensor data associated with a vehicle 150 and/or an environment associated therewith. Additionally, or alternatively, in some embodiments, the one or more vehicle onboard systems 102 include one or more computing devices and/or systems embodied in hardware, software, firmware, and/or a combination thereof, that control operation of one or more physical components of the vehicle 150, including and without limitation, one or more displays, one or more flight management systems, one or more engines, one or more wings, one or more props, one or more landing gear assemblies, one or more sensors, and/or the like. Additionally, or alternatively, in some embodiments, the one or more vehicle onboard systems 102 include one or more computing devices and/or systems that generate one or more user interfaces capable of being rendered to one or more displays of the one or more vehicle onboard systems 102. Additionally, or alternatively, in some embodiments, the one or more vehicle onboard systems 102 include one or more computing devices and/or systems that generates and/or maintains data embodying and/or utilized to recreate a virtual environment including virtual aspects corresponding to and/or associated with a real-world environment and/or a virtual vehicle corresponding to the actual vehicle. It will be appreciated that the vehicle 150 may include any number of physical components that enable the vehicle 150 to operate in a particular manner of airborne, space, aquatic, and/or ground-based travel.

In some embodiments, the one or more vehicle onboard systems 102 include one or more personal computers, one or more end-user terminals, one or more monitors, and/or one or more displays. Additionally, or alternatively, in some embodiments, the one or more vehicle onboard systems 102 include one or more data repositories embodied in hardware, software, firmware, and/or any combination thereof to support functionality provided by one or more computing devices of the one or more vehicle onboard systems 102. In some embodiments the one or more vehicle onboard systems 102 include one or more specially configured integrated systems that process data received by and/or controlled by one or more other computing devices and/or systems of the one or more vehicle onboard systems 102.

The one or more other connected vehicle systems 104 may include one or more computing devices, systems, and/or onboard systems of one or more other vehicles in communication with the vehicle 150. It will be appreciated that the one or more other connected vehicle systems 104 in some embodiments include one or more computing devices and/or one or more systems of one or more other vehicles of the same type operating within the same environment as the vehicle 150. For example, in some embodiments some of the other connected vehicle systems 104 include one or more computing devices and/or systems of one or more other vehicles in a fleet of a particular type of vehicle. Additionally, or alternatively, in some embodiments, the one or more other connected vehicle systems 104 include one or more computing devices and/or systems of one or more ground vehicles, one or more other types of vehicles, and/or the like.

In some embodiments, the one or more vehicle onboard systems 102 receive data from one or more of the other connected vehicle systems 104 that provides additional context with respect to the environment in which the vehicle 150 is operating. For example, in some embodiments, the one or more vehicle onboard systems 102 communicate with one or more other connected vehicle systems 104 to determine a position of one or more other vehicles, objects, environmental features (e.g., buildings, terrain, and/or the like) within the environment of the vehicle 150. Additionally, or alternatively, in some embodiments, the one or more vehicle onboard systems 102 communicate with one or more of the other connected vehicle systems 104 to receive flight sensor data of a particular data type that is not capturable directly by the one or more vehicle onboard systems 102. For example, in some embodiments, the vehicle 150 does not include a particular sensor for capturing a particular type of data, and instead receives such data of the particular data type from the one or more other connected vehicle systems 104.

In some embodiments, the one or more vehicle onboard systems 102 may include one or more flight management systems, which may themselves include one or more computing devices embodied in hardware, software, firmware, and/or the like that generate, assign, and/or maintain flight plan information and/or other flight detail data for the vehicle 150 and/or one or more other vehicles. For example, in some embodiments, the one or more flight management systems include one or more computing devices and/or systems of an air traffic control (ATC) system and/or other authoritative entity that assigns flight detail data (e.g., one or more particular flight plans and/or information associated therewith, one or more transportation corridors) to one or more vehicles 150. Such information may include, without limitation, flight detail data embodying a visual flight rules (VFR) flight plan, an instrument flight rules (IFR) flight plan, a composite flight plan, and/or the like defining conditions for operating a vehicle 150 within a particular environment.

In some embodiments, the one or more flight management systems include one or more application servers, one or more end user terminals, one or more personal computers, one or more mobile devices, one or more user devices, and/or the like that generate, assign, and/or transmit flight detail data to one or more vehicles 150. Additionally, or alternatively, in some embodiments, the one or more flight management systems may include one or more data repositories embodied in hardware, software, firmware, and/or a combination thereof, that store flight detail data, links between flight detail data and one or more particular vehicle 150, and/or the like. Additionally, or alternatively, in some embodiments, the one or more flight management systems include one or more computing devices and/or systems that detect and/or monitor operation of one or more vehicles 150 within an environment. For example, in some embodiments, the one or more flight management systems include one or more radar systems that monitor the position of one or more vehicles 150 within a particular portion of an environment.

In some embodiments, the one or more other connected vehicle systems 104 may be examples of systems and/or devices capable of communicating or otherwise sharing data with the one or more vehicle onboard systems 102. The one or more other connected vehicle systems 104 may be ground-based or air-based. In some examples, the one or more other connected vehicle systems 104 may generate data. That is, data may originate from the one or more other connected vehicle systems 104. Additionally, or alternatively, the one or more other connected vehicle systems 104 may receive data that originates from one or more other sources and communicate or otherwise relay the data to one or more devices. The one or more other connected vehicle systems 104 may include one or more data storage systems, such as volatile or non-volatile memory devices. Some illustrative examples of one or more other connected vehicle systems 104 may include other vehicles, weather monitoring systems, ATC systems, and/or the like.

The one or more other connected vehicle systems 104 may include one or more computing devices and/or systems that store and/or generate data. In some examples, the data may represent one or more aspects of a real-world environment, object therein, and/or vehicle 150 therein. In some embodiments, the one or more other connected vehicle systems 104 include one or more data repositories that store data embodying terrain of a particular environment. Additionally, or alternatively, in some embodiments, the one or more other connected vehicle systems 104 include one or more data repositories that store data embodying one or more buildings, one or more objects and/or one or more other features within the environment that one or more vehicles 150 in the environment is to avoid or interact with (e.g., for takeoff and/or landing). In some embodiments, the one or more other connected vehicle systems 104 embody a subsystem of the one or more flight management systems and/or the one or more vehicle onboard systems 102. In some embodiments, the one or more other connected vehicle systems 104 include a cityscape obstacle database, a vertiport database (e.g., including locations, dimensions, and/or other characteristic of one or more landing zones), and/or the like.

In some embodiments, the one or more other connected vehicle systems 104 include one or more application servers, one or more end user terminals, one or more personal computers, one or more mobile devices, one or more user devices, and/or the like. Additionally, or alternatively, in some embodiments, the one or more other connected vehicle systems 104 include one or more database server specially configured to store data pushed from one or more other computing devices and/or systems (e.g., the one or more vehicle onboard systems 102, one or more flight management systems, and/or the like) and/or retrieve data in response to one or more queries from one or more other computing devices and/or systems. In some embodiments, the one or more other connected vehicle systems 104 include one or more remote and/or cloud computing devices accessible to the one or more vehicle onboard systems 102 and/or one or more flight management systems over a communications network, such as the communications network 110.

In some embodiments, the transportation corridor database 106 may include one or more hardware and/or software components configured to store information, such as vehicle-relevant information. For example, the transportation corridor database 106 may include one or more data repositories embodied in hardware, software, firmware, and/or a combination thereof, that store flight detail data, links between flight detail data and one or more particular vehicle 150, and/or the like. In some examples, the transportation corridor database 106 may include one or more data storage systems, such as volatile or non-volatile memory devices. In one illustrative example, the transportation corridor database 106 may store information associated with one or more transportation corridors.

In some examples, the transportation corridor database 106 may store a plurality of data entries. Each data entry may include information associated with a respective transportation corridor. For example, a data entry may include an identifier for a transportation corridor (e.g., a name, an identification string), one or more geographic identifiers (e.g., waypoints, coordinates) for the transportation corridor, and/or one or more rules (e.g., performance requirements) that specify one or more vehicle types and/or criteria for using the transportation corridor. In some examples, the transportation corridor database 106 may include data for one or more transportation corridors for one or more specific types of vehicles. For example, the transportation corridor database 106 may include a plurality of transportation corridors for vertical takeoff and landing (VTOL) vehicles.

In some examples, one or more processors (e.g., of a vehicle onboard system 102) may receive information associated with one or more transportation corridors (e.g., an indication of one or more transportation corridors, one or more identifiers for one or more transportation corridors, and/or the like) from a transportation corridor database 305. In some examples, the one or more transportation corridors and/or the information associated with the one or more transportation corridors may be received from one or more other connected vehicle systems 104 (e.g., a ground-based computing device). In some examples, one or more processors may receive a list or a set of all available transportation corridors from the transportation corridor database 106. In some examples, the list or the set may include all available transportation corridors for a specific vehicle type, such as all VTOL transportation corridors.

In some embodiments the communications network 110 enables communication between the various computing devices and/or systems utilizing one or more combinations of wireless and/or wired data transmissions and protocols. In this regard, the communications network 110 may embody any of a myriad of network configurations. In some embodiments, the communications network 110 embodies a public network (e.g., the internet) in whole or in part. In some embodiments, the communications network 110 embodies a private network (e.g., an internal network between particular computing devices) in whole or in part. Additionally, or alternatively, in some embodiments the communications network 110 embodies a direct or private connection facilitated over satellite and/or radio systems that enable long-range communication between the vehicle 150 and corresponding grounded systems. In some other embodiments, the communications network 110 embodies a hybrid network (e.g., a network enabling internal communications between connected computing devices and external communications with other computing devices).

The communications network 110 may include one or more base stations, one or more relays, one or more routers, one or more switches, one or more cell towers, one or more communications cables, one or more satellites, one or more radio antennas, and/or one or more related control systems and/or associated routing stations. In some embodiments, the communications network 110 includes one or more user entity-controlled computing devices and/or other enterprise devices (e.g., an end-user or enterprise router, modem, switch, and/or other network access point) and/or one or more external utility devices (e.g., one or more internet service provider communication towers, one or more cell towers, and/or one or more other devices). In some embodiments, the one or more vehicle onboard systems 102 communicate with the one or more other connected vehicle systems 104 over the communications network 110 to receive and/or transmit encoded image data and/or feedback messages as described herein.

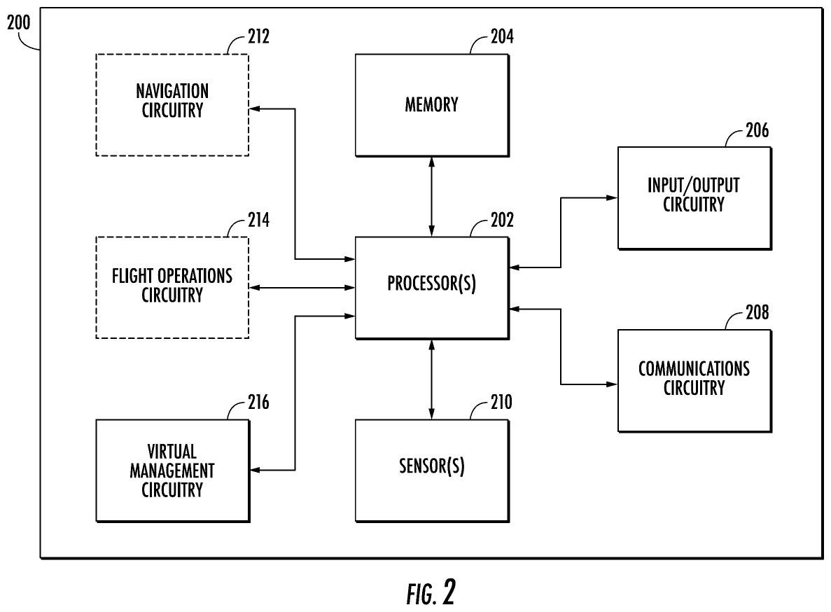

FIG. 2 illustrates a block diagram of a computing device for providing transportation corridor recommendations in accordance with one or more embodiments of the present disclosure. Specifically, FIG. 2 depicts a computing device 200. In some embodiments, the one or more vehicle onboard systems 102, the one or more other connected vehicle systems 104, and/or the transportation corridor database 106 described with reference to FIG. 1 may include one or more computing devices 200. As depicted, the computing device 200 includes one or more processors 202, one or more memories 204, input/output circuitry 206, communications circuitry 208, one or more sensors 210, navigation circuitry 212, flight operations circuitry 214, and/or virtual management circuitry 216. In some such embodiments, the navigation circuitry 212 and/or the flight operations circuitry 214 is/are optional.

In some embodiments, the computing device 200 is configured, using one or more of the sets of circuitry embodying the processor 202, the memory 204, the input/output circuitry 206, the communications circuitry 208, the one or more sensors 210, the navigation circuitry 212, the flight operations circuitry 214, and/or the virtual management circuitry 216, to execute any one or more of the operations described herein. Although components are described with respect to functional limitations, the particular implementations may include the user of the particular computing hardware, who may provide inputs to and/or receive outputs from the computing device 200 via the input/output circuitry 206. It should also be understood that in some embodiments certain components described herein include similar or common hardware. For example, two sets of circuitry may both leverage use of the same processor, network interface, storage medium, and/or the like, to perform their associated functions, such that duplicate hardware is not required for each set of circuitry. The use of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Additionally, or alternatively, in some embodiments, other elements of the computing device 200 provide or supplement the functionality of another particular set of circuitry. For example, the processor 202 in some embodiments provides processing functionality to any of the other sets of circuitry, the memory 204 provides storage functionality to any of other the sets of circuitry, the communications circuitry 208 provides network interface functionality to any of the other sets of circuitry, and/or the like.

In some embodiments, the processor 202 (and/or co-processor or any other processing circuitry assisting or otherwise associated with the processor) is/are in communication with the memory 204 via a bus for passing information among components of the computing device 200. In some embodiments, for example, the memory 204 is non-transitory and includes, for example, one or more volatile and/or non-volatile memories. In other words, for example, the memory 204 may include or embody an electronic storage device (e.g., a computer readable storage medium). In some embodiments, the memory 204 is configured to store information, data, content, applications, instructions, or the like, for enabling the computing device 200 to carry out various functions in accordance with example embodiments of the present disclosure.

In various embodiments, the processor 202 is embodied in a number of different ways. For example, in some example embodiments, the processor 202 includes one or more processing devices configured to operate independently. Additionally, or alternatively, in some embodiments, the processor 202 includes a processor configured in tandem via a bus to enable independent execution of instructions, pipelining, and/or multithreading. The use of the terms “processor” and “processing circuitry” should be understood to include a single core processor, a multi-core processor, multiple processors internal to the computing device 200, and/or one or more remote or cloud-based processors external to the computing device 200.

In an example embodiment, the processor 202 is configured to execute instructions stored in the memory 204 or otherwise accessible to the processor 202. Additionally, or alternatively, the processor 202 may be configured to execute hard-coded functionality. As such, whether configured by hardware or software methods, or by a combination thereof, the processor 202 represents an entity (e.g., physically embodied in circuitry) capable of performing operations according to an embodiment of the present disclosure while configured accordingly. Additionally, or alternatively, as another example, when the processor 202 is embodied as an executor of software instructions, the instructions specifically configure the processor 202 to perform the algorithms embodied in the specific operations described herein when such instructions are executed.

In some embodiments, computing device 200 includes input/output circuitry 206 and/or communications circuitry 208 that provides output to a user and, in some embodiments, transmits encoded image data to one or more other devices. In some embodiments, the input/output circuitry 206 and/or the communications circuitry 208 is/are in communication with the processor 202 to provide such functionality. The input/output circuitry 206 may comprise one or more user interfaces and in some embodiments includes one or more displays that comprise the one or more interfaces rendered as a web user interface, an application user interface, a user device, a backend system, or the like. In some embodiments, the input/output circuitry 206 also includes a keyboard, a mouse, a joystick, a touch screen, touch areas, soft keys, a microphone, a speaker, or other input/output mechanisms. The processor 202, and/or input/output circuitry 206 comprising a processor, in some embodiments is configured to control one or more functions of one or more user interface elements through computer program instructions (e.g., software and/or firmware) stored on a memory accessible to the processor 202 (e.g., memory 204, and/or the like). In some embodiments, the input/output circuitry 206 includes or utilizes a user-facing application to provide input/output functionality to a service maintainer device and/or other display associated with a user.

The communications circuitry 208 includes any means such as a device or circuitry embodied in either hardware or a combination of hardware and software that is configured to receive and/or transmit data from/to a communications network and/or any other computing device, circuitry, or module in communication with the computing device 200. In this regard, the communications circuitry 208 includes, for example in some embodiments, a network interface for enabling communications with a wired or wireless communications network. Additionally, or alternatively in some embodiments, the communications circuitry 208 includes one or more network interface cards, one or more antennas, one or more busses, one or more switches, one or more routers, one or more modems, and supporting hardware, firmware, and/or software, or any other device suitable for enabling communications via one or more communication networks. Additionally, or alternatively, the communications circuitry 208 includes circuitry for interacting with the one or more antennas and/or other hardware or software to cause transmission of signals via the one or more antennas or to handle receipt of signals received via the one or more antennas. In some embodiments, the communications circuitry 208 enables transmission to and/or receipt of data from one or more computing devices and/or systems of one or more other connected vehicle systems 104 and/or one or more flight management systems in communication with the computing device 200.

The one or more sensors 210 include hardware, software, firmware, and/or a combination thereof, that supports generation, capturing, aggregating, retrieval, and/or receiving of one or more portions of data, such as flight sensor data and/or image data. In some embodiments, the one or more sensors 210 include one or more components of a vehicle. The one or more sensors 210 in some embodiments are affixed to, within, and/or otherwise a part of a vehicle including or otherwise associated with the computing device 200. For example, in some embodiments, one or more of the sensors 210 are mounted to the vehicle. Non-limiting examples of sensors 210 include altimeters (e.g., radio and/or barometric), pressure sensors, pitot tubes, anemometers, image cameras, video cameras, infrared sensors, and/or the like. Additionally, or alternatively, in some embodiments, the one or more sensors 210 include one or more communication systems that enable aggregation of one or more portions of flight sensor data from one or more external computing devices and/or systems communicable with the computing device 200, for example one or more other connected vehicle systems 104 and/or one or more flight management systems. In some embodiments, the one or more sensors 210 include any of a myriad of sensors conventionally associated with drones, helicopters, and/or other urban air mobility vehicles. Additionally, or alternatively, in some embodiments, the one or more sensors 210 include one or more high-sensitivity sensors to facilitate and/or enable high accuracy capturing of data in certain circumstances. For example, in some embodiments, the one or more sensors 210 include one or more high-sensitivity altimeters that capture detailed altitude information within a few feet (e.g., within tens of feet) from a landing zone. In this regard, such high-sensitivity sensors in some embodiments provide higher-accuracy data when a vehicle is close to a landing zone, where such higher-accuracy data is utilized in depicting accurate positioning of a virtual vehicle corresponding to the vehicle within a virtual environment with respect to a virtual representation of the landing zone and/or a virtual corridor.

In some embodiments, the one or more sensors 210 include hardware, software, firmware, and/or a combination thereof, embodying one or more navigation sensors. In some embodiments, the one or more navigation sensors include a global positioning satellite (GPS) tracking chip and/or the like enabling location services to be requested and/or determined for a particular vehicle. Additionally, or alternatively, in some embodiments, the one or more sensors 210 include hardware, software, firmware, and/or any combination thereof, embodying one or more inertial navigation sensors that measure speed, acceleration, orientation, and/or position-related data in a 3D environment. Additionally, or alternatively, in some embodiments, the one or more sensors 210 include one or more cameras associated with a synthetic vision system (SVS). In some such embodiments, such an SVS camera captures image data representations of the real-world environment around a vehicle for use in generating one or more corresponding user interface depicting the captured image data, augmenting such image data, and/or otherwise providing data to enable an operator to acquire situational awareness based at least in part on the captured image data. It will be appreciated that, in some embodiments, the one or more sensors 210 include a separate processor, specially configured field programmable gate array (FPGA), or a specially programmed application specific integrated circuit (ASIC).

The navigation circuitry 212, which may optionally be included, includes hardware, software, firmware, and/or a combination thereof, that supports various functionality associated with navigating a vehicle. In some embodiments, navigation circuitry 212 includes hardware, software, firmware, and/or a combination thereof, that receives flight plan data, location service data representing a location of the vehicle, and/or the like. Additionally, or alternatively, in some embodiments, the navigation circuitry 212 includes hardware, software, firmware, and/or a combination thereof, that determines a location of a landing zone from which a vehicle is taking off and/or where a vehicle is landing. Additionally, or alternatively, in some embodiments, the navigation circuitry 212 includes hardware, software, firmware, and/or a combination thereof, that determines a location along a flight path at which a vehicle is to switch operational mode (e.g., to initiate change to and/or from a vertical landing mode and/or vertical takeoff mode). It will be appreciated that, in some embodiments, navigation circuitry 212 includes a separate processor, specially configured FPGA, or a specially programmed ASIC.

The flight operations circuitry 214, which may optionally be included, includes hardware, software, firmware, and/or a combination thereof, that supports various functionality associated with controlling a vehicle. In some embodiments, the flight operations circuitry 214 includes hardware, software, firmware, and/or a combination thereof, that autonomously control one or more components of a vehicle to facilitate movement of the vehicle along a particular flight path. Additionally, or alternatively, in some embodiments, the flight operations circuitry 214 includes hardware, software, firmware, and/or a combination thereof, that semi-autonomously control one or more components of a vehicle, for example where certain aspects of the operation of the vehicle are autonomously performed and others (e.g., directional control) is/are controlled by a user (e.g., a pilot). Additionally, or alternatively, in some embodiments, the flight operations circuitry 214 includes hardware, software, firmware, and/or a combination thereof, that receives pilot input for controlling one or more components of a vehicle, for example via vehicle flight controls to alter speed and/or direction of the vehicle. Additionally, or alternatively, in some embodiments, the flight operations circuitry 214 includes hardware, software, firmware, and/or a combination thereof, that causes changes to an operational mode of a vehicle, for example autonomously based at least in part on one or more data-driven events and/or triggers, or in response to user input initiating the change in operational mode. It will be appreciated that, in some embodiments, the flight operations circuitry 214 includes a separate processor, specially configured FPGA, or a specially programmed ASIC.

The virtual management circuitry 216 includes hardware, software, firmware, and/or a combination thereof, that supports various functionality associated with generating and/or maintaining one or more virtual elements and/or outputting one or more urban air mobility (UAM) visualization interfaces embodying one or more views of one or more virtual elements. In some embodiments, the virtual management circuitry 216 includes hardware, software, firmware, and/or a combination thereof, that generates a virtual environment based at least in part on flight sensor data. Additionally, or alternatively, in some embodiments, the virtual management circuitry 216 includes hardware, software, firmware, and/or a combination thereof, that generates a virtual vehicle based at least in part on flight sensor data, the virtual vehicle corresponding to a vehicle in a real-world environment. Additionally, or alternatively, in some embodiments, the virtual management circuitry 216 includes hardware, software, firmware, and/or a combination thereof, that generates a virtual corridor based at least in part on flight sensor data. Additionally, or alternatively, in some embodiments, the virtual management circuitry 216 includes hardware, software, firmware, and/or a combination thereof, that maintains one or more virtual elements (e.g., a virtual environment, virtual vehicle, virtual corridor, and/or the like) as new data is received. For example, in some embodiments, the virtual management circuitry 216 updates a speed, direction, velocity, altitude, and/or other data value associated with a virtual vehicle in a virtual environment as updated flight sensor data associated with a corresponding vehicle is received. Additionally, or alternatively, in some embodiments, the virtual management circuitry 216 includes hardware, software, firmware, and/or a combination thereof, that outputs data embodying a UAM visualization interface from a particular view with respect to the virtual vehicle, for example a profile view, an exocentric view, and/or an egocentric view.

In some embodiments, the virtual management circuitry 216 includes hardware, software, firmware, and/or any combination thereof, that generates one or more user interface elements and/or otherwise causes rendering of one or more user interfaces including one or more specially configured user interface elements. For example, in some embodiments, the virtual management circuitry 216 includes hardware, software, firmware, and/or a combination thereof that generates one or more virtual elements to be depicted via a UAM visualization interface. For example, in some embodiments, the virtual management circuitry 216 generates a UAM visualization interface depicting a virtual corridor, with or without reliance on maintaining a virtual environment. In some embodiments, the virtual management circuitry 216 includes a graphics processor that generates one or more specially configured virtual user interface elements (e.g., a representation of a virtual corridor) based at least in part on flight sensor data, and/or generating sub-interfaces including some or all of such virtual user interface elements and/or other interface elements. Additionally, or alternatively, in some embodiments, the virtual management circuitry 216 includes one or more displays embodied in hardware, software, firmware, and/or a combination thereof, that render one or more user interfaces and/or elements thereof. It will be appreciated that, in some embodiments, virtual management circuitry 216 includes a separate processor, specially configured FPGA, or a specially programmed ASIC.

It will be appreciated that, in some embodiments, two or more of the sets of circuitries 202-216 are combinable. Additionally, or alternatively, in some embodiments, one or more of the sets of circuitry 202-216 perform some or all of the functionality described associated with another component. For example, in some embodiments, one or more of the sets of circuitry 202-216 are combined into a single component embodied in hardware, software, firmware, and/or a combination thereof. For example, in some embodiments, two or more of the navigation circuitry 212, flight operations circuitry 214, and/or virtual management circuitry 216 are embodied by a single set of circuitry that performs the combined operations of the individual sets of circuitry. Similarly, in some embodiments, one or more of the sets of circuitry, for example navigation circuitry 212, flight operations circuitry 214, and/or virtual management circuitry 216, is/are combined with the processor 202, such that the processor 202 performs one or more of the operations described above with respect to each of these other sets of circuitry.

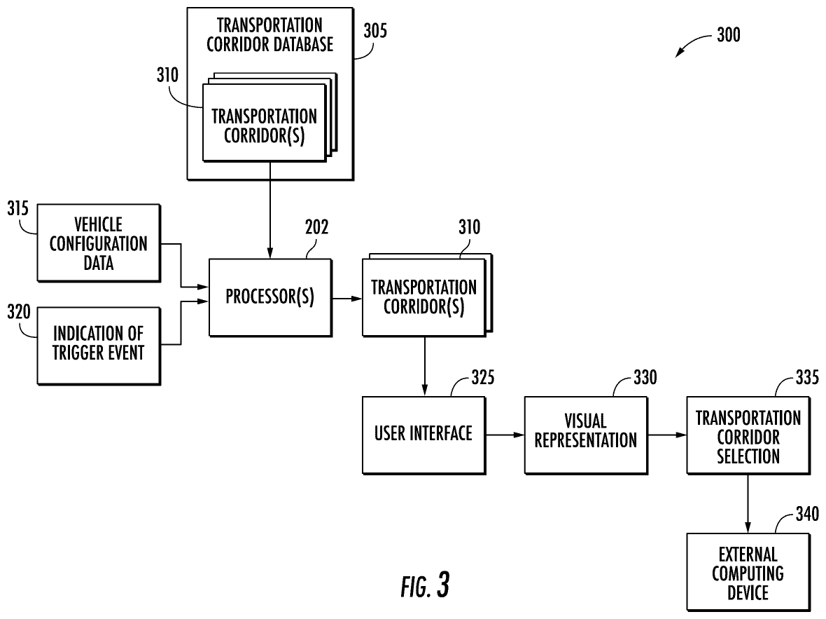

FIG. 3 is a dataflow diagram 300 showing example data structures and modules for providing transportation corridor recommendations in accordance with at least some embodiments of the present disclosure. In some examples, one or more processors 202 may receive one or more transportation corridors 310 (e.g., a set of transportation corridors 310). The one or more transportation corridors 310 may be received from a transportation corridor database 305. In some embodiments, a transportation corridor 310 may be a pathway, route, or portion of an environment where one or more vehicles are configured to or otherwise permitted to travel. In some examples, a transportation corridor 310 may be a three-dimensional pathway, which may be mapped or represented using one or more coordinates and/or one or more trajectories (e.g., straight lines and/or curved lines). In some examples, a transportation corridor 310 may be a region of space. For example, a transportation corridor 310 may be a region of space between an upper altitude boundary and a lower altitude boundary. In some examples, a vehicle may receive one or more indications of one or more transportation corridors 310 or otherwise be configured to operate within one or more transportation corridors 310.

In some examples, transportation corridors 310 may provide a mechanism of separation between various vehicles and/or types of vehicles. For example, transportation corridors 310 may be utilized by VTOL vehicles to maintain separation between VTOL vehicles and other types of vehicles. Within transportation corridors 310, separation is maintained by vehicle operators, such as UASPs. Each transportation corridor 310 may be associated with one or more performance requirements such as maneuverability requirements or sense-and-avoid requirements to ensure more efficient operations. For example, a transportation corridor 310 that is near or intersects with a region having a relatively high volume of traffic when compared to other transportation corridors 310 may have a more stringent sense-and-avoid requirement when compared to the other transportation corridors 310. In some examples, transportation corridors may enable existing traffic to coexist safely with eVTOL vehicles while maximizing the capacity of urban airspace.

In some embodiments, a transportation corridor database 305 may be an information repository or a storage location for storing information associated with one or more transportation corridors 310. For example, a transportation corridor database 305 may store a plurality of data entries. Each data entry may include information associated with a respective transportation corridor 310. For example, a data entry may include an identifier for a transportation corridor 310 (e.g., a name, an identification string), one or more geographic identifiers (e.g., waypoints, coordinates) for the transportation corridor 310, and/or one or more rules (e.g., performance requirements, vehicle configuration requirements) that specify one or more vehicle types and/or criteria for using the transportation corridor 310. In some examples, a transportation corridor database 305 may include one or more transportation corridors 310 for one or more specific types of vehicles. For example, a transportation corridor database 305 may include a plurality of transportation corridors 310 for VTOL vehicles.

In some examples, one or more processors 202 (e.g., of a vehicle, of a computing device associated with a vehicle) may receive one or more transportation corridors 310 (e.g., an indication of one or more transportation corridors 310, one or more identifiers for one or more transportation corridors 310, and/or the like) from a transportation corridor database 305. Additionally, or alternatively, the one or more processors 202 may receive information associated with the one or more transportation corridors 310 from the transportation corridor database 305. In some examples, the one or more transportation corridors 310 and/or the information associated with the one or more transportation corridors 310 may be received from a computing device that stores the transportation corridor database 305 (e.g., a ground-based computing device). In some examples, one or more processors 202 may receive a list or a set of all available transportation corridors 310 from the transportation corridor database 305. In some examples, the list or the set may include all available transportation corridors 310 for a specific vehicle type, such as all VTOL transportation corridors 310.

In some examples, the one or more processors 202 may receive vehicle configuration data 315 for a vehicle. In some examples, the vehicle configuration data 315 may be received from the vehicle (e.g., from one or more subsystems of the vehicle). In some examples, the vehicle configuration data 315 may be received from one or more computing devices, such as one or more ground-based computing devices. In some embodiments, vehicle configuration data 315 may be information indicative of one or more configurations, capabilities, and/or characteristics of a vehicle. In some examples, vehicle configuration data 315 may be utilized to determine if one or more transportation corridors 310 are appropriate, viable, or permitted for use by a specific vehicle. As described herein, some non-limiting examples of vehicle configuration data 315 may include vehicle size data, vehicle weight data, vehicle capability data, vehicle navigational data, vehicle type data, and/or the like. Accordingly, one or more transportation corridors 310 may be selected (e.g., by one or more processors 202) for use by a vehicle based on one or more types of vehicle configuration data 315. For example, a transportation corridor 310 may be selected or otherwise determined to be appropriate for use by a given vehicle if a weight of the vehicle is below a threshold weight.

In some examples, one or more processors 202 may perform one or more operations to select or otherwise generate a subset of transportation corridors 310 based on vehicle configuration data 315 for a vehicle. For example, the one or more processors 202 may select the subset of transportation corridors 310 from a set of all available transportation corridors 310 provided by a transportation corridor database 305. Accordingly, the one or more processors 202 may determine the subset of transportation corridors 310 for providing to a specific vehicle or one or more individuals associated with the specific vehicle (e.g., a pilot of the specific vehicle, one or more air-based and/or ground-based crew members for the specific vehicle). By doing so, the specific vehicle may avoid utilizing transportation corridors 310 that are not appropriate for the specific vehicle. Additionally, or alternatively, the one or more individuals associated with the specific vehicle may avoid unnecessarily reviewing transportation corridors 310 that are not appropriate for the specific vehicle, which may result in improved operational efficiency and improved vehicle safety.

In some examples, the one or more processors 202 may receive an indication of a trigger event 320. In some examples, the indication of the trigger event may be received from one or more computing devices, such as a ground-based computing device and/or an air-based computing device (e.g., of another vehicle). In some embodiments, a trigger event may be an event that prompts or causes the occurrence of one or more actions, operations, or other events. For example, one or more processors 202 may select a subset of transportation corridors 310 based on a trigger event (e.g., based on the occurrence of the trigger event, based on receiving an indication that a trigger event has occurred). In some examples, one or more processors 202 may periodically and/or continuously monitor for the occurrence of a trigger event (e.g., a change in a state of a vehicle, receipt of an emergency alert, and/or the like). As described herein, some non-limiting examples of trigger events may include weather events, traffic-related events, flight management system (FMS) events, and/or vehicle status events. Additionally, or alternatively, the receipt of a message or information indicating the occurrence of a trigger event may itself be an example of a trigger event. For example, a trigger event may include receiving weather data, receiving traffic data, receiving FMS data, receiving vehicle status data, and/or the like. In some examples, a trigger event may include receiving specific types of data or specific data values (e.g., data values indicative of a specific condition). For example, receiving a message indicating wind speeds in a specific region greater than or equal to a wind speed threshold may be a trigger event.

In some examples, the one or more processors 202 may select one or more transportation corridors 310 (e.g., of the set of transportation corridors 310). For example, the one or more processors 202 may select a subset of transportation corridors 310. The selection may be based on the vehicle configuration data 315 (e.g., the one or more processors may select a subset of transportation corridors that are appropriate or valid in view of the vehicle configuration data 315) and/or the trigger event (e.g., the selection may be initiated based on the occurrence of the trigger event). In some examples, a visual representation 330 of one or more transportation corridors 310 (e.g., the subset of transportation corridors 310) and/or a visual representation 330 of a recommendation of one or more transportation corridors 310 (e.g., a single transportation corridor 310 of the subset) may be provided via a user interface 325 of the vehicle. In some examples, the one or more processors 202 may cause the one or more visual representations 330 to be provided (e.g., by generating and/or sending one or more control signals to the user interface 325). In some examples, the recommendation may be based on one or more efficiency metric values for the one or more transportation corridors 310.

In some embodiments, a user interface 325 may include hardware and/or software that is configured to interface with one or more individuals. For example, a user interface 325 may be a device that receives one or more inputs from a user and/or provides one or more outputs to the user, such as a monitor, a display, a speaker, a microphone, a printer, a keyboard, a mouse, a joystick, and/or the like. In some examples, a user interface 325 may be a software application, such as a graphical user interface 325 that is displayed and/or executed on a computing device. In some examples, a user interface 325 may provide an audio and/or visual representation 330 of information. For example, a user interface 325 of a vehicle, such as a display of a flight management system or any other computing device associated with a vehicle, may provide a representation of one or more transportation corridors 310 (e.g., a subset of transportation corridors 310) and/or a visual representation 330 of a recommendation (e.g., a recommended transportation corridor 310 of the subset). For example, a display screen in an aircraft may display a plurality of shapes (e.g., lines, pathways, and/or the like) representative of a plurality of transportation corridors 310. In some examples, a single shape of the plurality of shapes may be highlighted or displayed in a specific color, which may be representative of a recommendation of a single transportation corridor 310 of one or more potential transportation corridors 310 (e.g., the subset of transportation corridors 310).

In some embodiments, a visual representation 330 may be a depiction or image that is displayed or otherwise provided to one or more individuals. For example, a user interface 325 of a computing device may display a visual representation 330. As described herein, a visual representation 330 may depict one or more transportation corridors 310. Additionally, or alternatively, a visual representation 330 may include one or more features that emphasize or otherwise highlight a specific portion of the visual representation 330. For example, a visual representation 330 of a transportation corridor 310 may include highlighting indicating a recommendation associated with a portion of the visual representation 330 (e.g., the highlighting may emphasize a specific transportation corridor 310 of a subset of transportation corridors 310). Although various examples of the techniques described herein refer to visual representations 330, audio representations may also be utilized to emphasize or call attention to various features or aspects. For example, an audio notification (e.g., an audio message) may be provided to one or more individuals via one or more speakers. In some examples, an audio notification may describe or otherwise indicate a recommendation of one or more transportation corridors 310 of a subset of transportation corridors 310.

In some embodiments, an efficiency metric value may be a value that represents one or more efficiency metrics associated with a vehicle. For example, an efficiency metric value may include a fuel consumption value, a power consumption value, a distance value, a time value, a speed value, and/or any other value that may be used by one or more individuals to determine an optimal transportation corridor 310 for selection. In some examples, an efficiency metric value may be a composite value that aggregates or otherwise combines two or more efficiency metric values. As described herein, an efficiency metric value may be associated with a transportation corridor 310. For example, an efficiency metric value may represent an efficiency associated with a vehicle traveling from a start point to an end point via a transportation corridor 310. Accordingly, a user interface 325 may indicate one or more efficiency metric values (or a composite efficiency metric value) for each transportation corridor 310 that is available or displayed. In some examples, a user interface 325 may display one or more efficiency metric values (or a composite efficiency metric value) in response to an individual (e.g., a user) placing a cursor over a specific region, such as a region including a representation of a specific transportation corridor 310. In some examples, a user interface 325 may display the one or more efficiency metric values (or the composite efficiency metric value) in response to an individual selecting a corresponding transportation corridor 310 (e.g., by pressing a corresponding button on a user interface 325 and/or by pressing a portion of a touchscreen display).

In some examples, an indication of a transportation corridor selection 335 may be received (e.g., by the one or more processors 202) via the user interface 325 of the vehicle. The transportation corridor selection 335 may be determined by one or more occupants of the vehicle, such as a pilot of the vehicle. In some embodiments, a transportation corridor selection 335 may include one or more transportation corridors 310 that are selected by one or more individuals. For example, a transportation corridor selection 335 may include a transportation corridor 310 that is selected by a pilot of an aircraft. In some examples, one or more individuals may select a transportation corridor 310 by providing one or more inputs to a user interface 325. For example, a pilot of an aircraft may press a button or select a selectable shape displayed via a user interface 325 to select a transportation corridor 310. In some examples, a transportation corridor selection 335 may be communicated to one or more individuals and/or computing devices. For example, a pilot may select a transportation corridor 310 and the transportation corridor selection 335 may be communicated to one or more members of a ground crew. Automatically communicating the transportation corridor selection 335 to the ground crew may enable the ground crew to make more informed decisions when compared to conventional systems where pilot decisions may not be communicated to a ground crew, or where relatively slower manual communications may reduce operational efficiency.

In some embodiments, an occupant and/or an occupant of a vehicle may be an individual aboard a vehicle, such as a pilot, a crew member, or a passenger. In some examples, one or more occupants of a vehicle may participate in a decision making process for routing or otherwise controlling the vehicle. For example, one or more occupants of a vehicle may determine or select one or more transportation corridors 310 for the vehicle. In some examples, the one or more occupants may determine or select the one or more transportation corridors 310 for the vehicle from a subset of transportation corridors 310 provided to the one or more occupants by a user interface 325 of the vehicle. In some examples, the one or more occupants may determine or select the one or more transportation corridors 310 based on one or more recommendations indicating one or more optimal transportation corridors 310 (e.g., based on one or more efficiency metric values). As described herein, the one or more occupants may include a pilot, and/or one or more other occupants of a vehicle, such as in a scenario where the pilot is incapacitated.

In some examples, the one or more processors 202 may cause transmission of, to an external computing entity and/or computing device (e.g., to one or more other vehicle connected systems 104), the indication of the transportation corridor selection 335. In some embodiments, an external computing device 340 may be a computing device that is external to a vehicle. For example, an external computing device 340 may be a ground-based computing device and/or a computing device that is operated by a ground crew. As described herein, a computing device and/or entity (e.g., a cloud-based computing entity) associated with a vehicle (e.g., one or more processors 202 of the computing device) may cause transmission of an indication of a transportation corridor selection 335 to one or more external computing devices 340.

In some examples, the one or more processors 202 may receive a signal indicative of a request from the occupant of the vehicle for the efficiency metric value. The one or more processors 202 may then provide, via the user interface 325 of the vehicle, an indication of the efficiency metric value based on receiving the signal. In some examples, the signal may be generated based on the occupant of the vehicle positioning a cursor over a visual representation 330 of a transportation corridor 310 of the subset. In some embodiments, a cursor may be an indicator, pointer, or marker that is viewable via a user interface 325 and/or display. In some examples, a cursor may be generated by a computing device. The computing device may receive input from a user (e.g., via a touchscreen display, via a mouse, via a joystick) that facilitates movement of the cursor on the user interface 325 and/or display. In some examples, one or more individuals may position a cursor to facilitate or otherwise cause one or more operations to be performed. For example, placing a cursor in a specific location (e.g., over an icon, over a shape indicative of a transportation corridor 310) may cause one or more operations to be performed, such as the display of one or more types of information (e.g., efficiency information, one or more efficiency metric values). In some examples, placing the cursor in the specific location and pressing one or more buttons may cause the one or more operations to be performed (e.g., clicking a button on a mouse).

In some examples, the one or more processors 202 may provide, via the user interface 325 of the vehicle, the indication of the efficiency metric value for the transportation corridor 310 and/or a second indication of a second efficiency metric value for a second transportation corridor 310 of the subset of transportation corridors 310, wherein the transportation corridor selection 335 is based on the occupant of the vehicle comparing the efficiency metric value and the second efficiency metric value. In some examples, the transportation corridor selection 335 indicates that the occupant of the vehicle has selected the second transportation corridor 310. In some examples, the transportation corridor selection 335 indicates that the occupant of the vehicle has selected the transportation corridor 310.

In some examples, the vehicle configuration data 315 includes vehicle size data, vehicle weight data, vehicle capability data, vehicle navigational data, and/or vehicle type data. In some examples, the trigger event includes receiving weather data, traffic data, FMS data, and/or vehicle status data. In some examples, the one or more transportation corridors 310 (e.g., the set of transportation corridors 310) include multiple transportation corridors 310 below a threshold altitude (e.g., 10,000 feet, transportation corridors 310 for VTOLs). In some embodiments, a threshold altitude may be a value that is an upper or lower bound. For example, some vehicles, such as VTOLs, may be configured to operate at or below a threshold altitude of 10,000 feet. As described herein, various types of vehicles may be associated with various threshold altitudes for operation. Additionally, or alternatively, various transportation corridors 310 may be associated with one or more threshold altitudes. For example, one or more processors 202 may receive a set of transportation corridors 310 for VTOL vehicles. Accordingly, the set of transportation corridors 310 may include transportation corridors 310 below a threshold altitude, such as 10,000 feet.

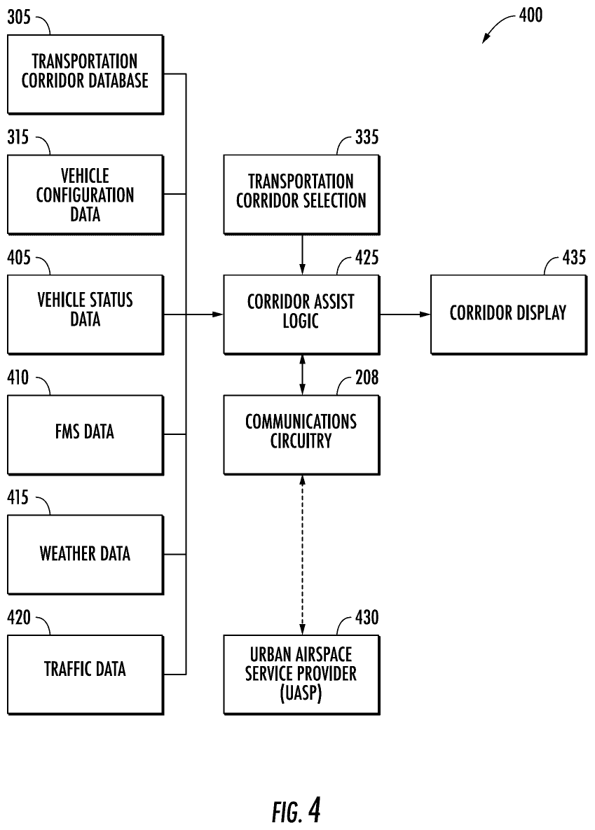

FIG. 4 is an operational example 400 of a flowchart that supports providing transportation corridor recommendations in accordance with at least some embodiments of the present disclosure. The operational example 400 may include a transportation corridor database 305, vehicle configuration data 315, vehicle status data 405, FMS data 410, weather data 415, traffic data 420, corridor assist logic 425, communications circuitry 208, a UASP 430, a corridor display 435, and a transportation corridor selection 335. As described herein, the corridor assist logic 425 may be executed by one or more processors, such as one or more processors of a vehicle. The corridor assist logic 425 may enable the one or more processors to generate a corridor display 435, which may indicate one or more recommendations of one or more transportation corridors. In some examples, the corridor assist logic 425 may generate the corridor display 435 and/or the one or more recommendations based on any one or more of one or more transportation corridors provided by a transportation corridor database 305, vehicle configuration data 315, vehicle status data 405, FMS data 410, weather data 415, and/or traffic data 420. In some examples, one or more individuals may receive the one or more recommendations and make one or more transportation corridor selections 335 based on the one or more recommendations. The one or more transportation corridor selections 335 may then be communicated by the one or more individuals to the corridor assist logic 425, which may then output the one or more transportation corridor selections 335 to a UASP 430 via communications circuitry 208.

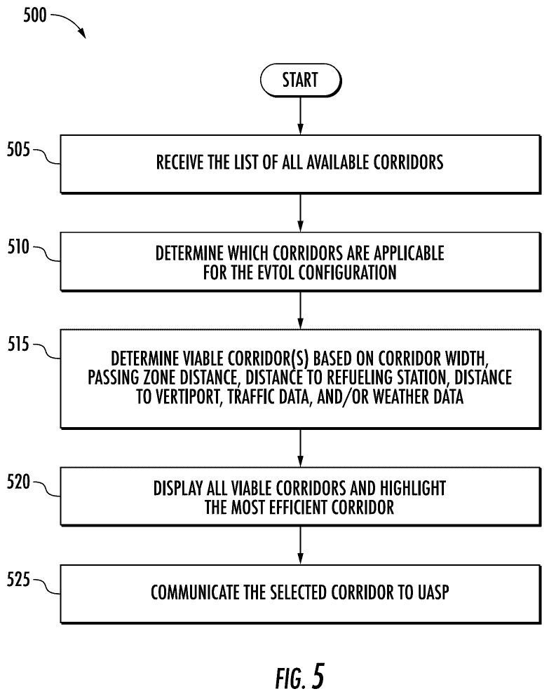

FIG. 5 is an operational example 500 of a process that supports providing transportation corridor recommendations in accordance with at least some embodiments of the present disclosure. In some embodiments, the process is embodied by computer program code stored on a non-transitory computer-readable storage medium of a computer program product configured for execution to perform the process as depicted and described. Additionally, or alternatively, in some embodiments, the process is performed by at least one specifically configured computing device, such as at least one computing device 200 alone or in communication with at least one other component, device, system, and/or the like. In this regard, in some such embodiments, the computing device 200 is specially configured by computer-coded instructions (e.g., computer program instructions) stored thereon, for example in the memory 204 and/or another component depicted and/or described herein and/or otherwise accessible to the computing device 200, for performing the operations as depicted and described. In some embodiments, the computing device 200 is in communication with at least one external apparatus, system, device, and/or the like, to perform at least one of the operations as depicted and described. For example, the computing device 200, in some embodiments, is in communication with an external computing device, a client device, and/or the like. For purposes of simplifying the description, the process is described as performed by and from the perspective of the computing device 200.

At operation 505, the computing device 200 includes means such as the sensors 210, navigation circuitry 212, flight operations circuitry 214, virtual management circuitry 216, communications circuitry 208, input/output circuitry 206, and/or processor 202, or a combination thereof, to receive a list of one or more transportation corridors. For example, the computing device 200 may receive a list of all available transportation corridors from a transportation corridor database.

At operation 510, the computing device 200 includes means such as the sensors 210, navigation circuitry 212, flight operations circuitry 214, virtual management circuitry 216, communications circuitry 208, input/output circuitry 206, and/or processor 202, or a combination thereof, to determine which corridors are applicable and/or viable for a specific configuration, such as a specific configuration of a eVTOL.

At operation 515, the computing device 200 includes means such as the sensors 210, navigation circuitry 212, flight operations circuitry 214, virtual management circuitry 216, communications circuitry 208, input/output circuitry 206, and/or processor 202, or a combination thereof, to determine one or more suitable (e.g., viable) corridors based on one or more of corridor width, passing zone distance, distance to a refueling station, distance to a vertiport, traffic data, and/or weather data.

At operation 520, the computing device 200 includes means such as the sensors 210, navigation circuitry 212, flight operations circuitry 214, virtual management circuitry 216, communications circuitry 208, input/output circuitry 206, and/or processor 202, or a combination thereof, to display all viable corridors (e.g., via a user interface). In some examples, the computing device may highlight a most efficient corridor (e.g., a corridor recommendation).

At operation 525, the computing device 200 includes means such as the sensors 210, navigation circuitry 212, flight operations circuitry 214, virtual management circuitry 216, communications circuitry 208, input/output circuitry 206, and/or processor 202, or a combination thereof, to communicate the selected corridor to a UASP. As described herein, the corridor may be selected by one or more individuals, such as a pilot of an eVTOL.

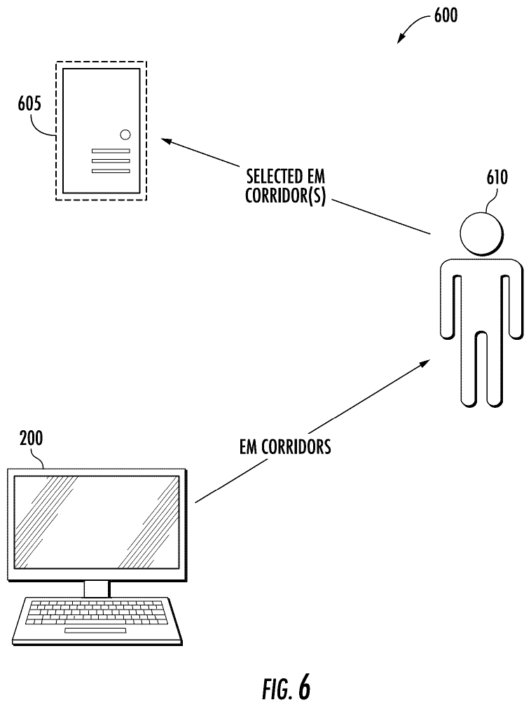

FIG. 6 is an operational example 600 of a communication diagram that supports providing transportation corridor recommendations in accordance with at least some embodiments of the present disclosure. In accordance with the operational example 600, a computing device 200 may execute any of the techniques described herein (e.g., the computing device 200 may execute a corridor selection algorithm). In some examples, the computing device 200 may run a corridor selection algorithm continuously. In some examples, the computing device 200 may provide or otherwise display one or more messages to an individual, such as a pilot 610, in response to the occurrence of an emergency scenario. For example, the computing device 200 may provide one or more transportation corridors (e.g., emergency mode (EM) corridors) to the pilot 610 in response to an emergency weather event. The pilot 610 may then select a transportation corridor of the one or more transportation corridors provided by the computing device 200. The pilot 610 and/or the vehicle operated by the pilot 610 may execute a flight plan path as per the selected transportation corridor (e.g., the pilot 610 may navigate the vehicle onto and along the selected transportation corridor). In some examples, a message may be communicated to an unmanned traffic management (UTM) virtual server 605. For example, the computing device 200 may receive an indication of the selected transportation corridor from the pilot 610 and communicate the indication of the selected transportation corridor to the UTM virtual server 605.

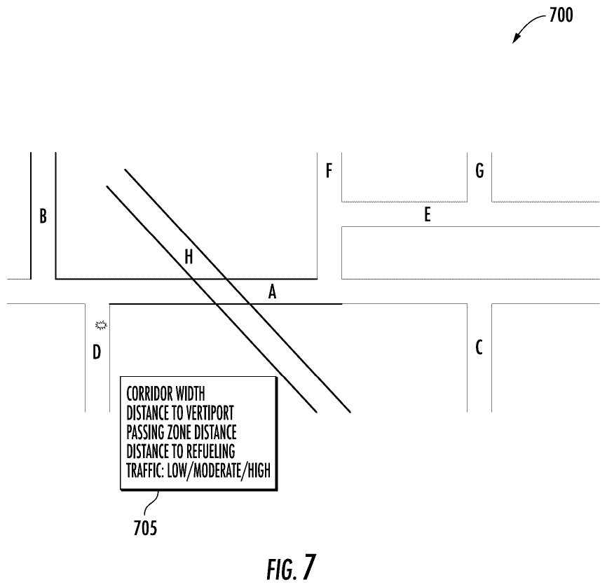

FIG. 7 is an operational example 700 of a user interface display that supports providing transportation corridor recommendations in accordance with at least some embodiments of the present disclosure. In accordance with the operational example 700, a user interface display may include one or more representations of transportation corridors, such as the transportation corridors A through H. The user interface display may provide an indication of each usable transportation corridor and/or an indication of a recommendation (e.g., an indication of an optimal transportation corridor). For example, a first line weighting, shading pattern, color, or other type of indication may be utilized to show that transportation corridor H is recommended (e.g., transportation corridor H is an optimal transportation corridor) and a second line weighting, shading pattern, color, or other type of indication may be utilized to show that transportation corridors B and A are viable, although not optimal and/or recommended. In some examples, a third line weighting, shading pattern, color, or other type of indication may be utilized to show that transportation corridors D, F, E, G, and C are not viable. In some examples, one or more types of information, such as one or more efficiency metrics may be displayed for a transportation corridor (e.g., in response to a user positioning a cursor on top of a transportation corridor). For example, a dialogue box 705 may be displayed that includes one or more of a corridor width, a distance to a vertiport, a passing zone distance, a distance to refueling, and/or a traffic density.

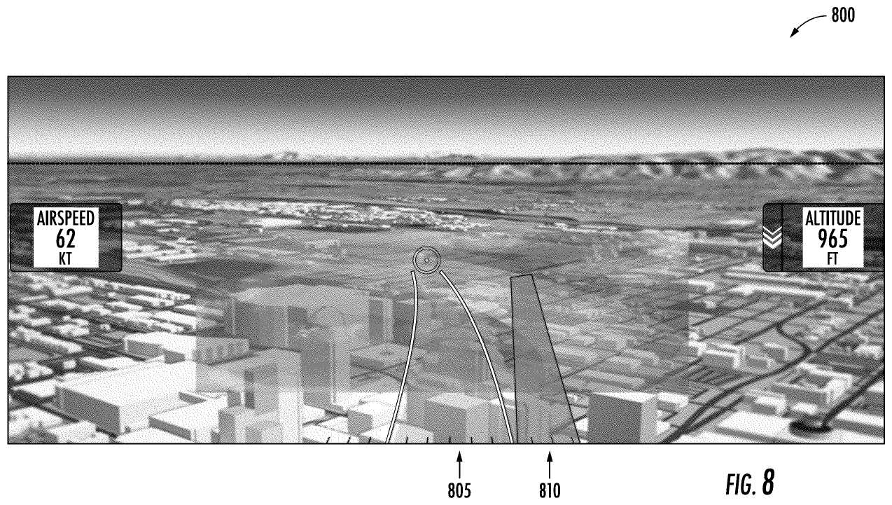

FIG. 8 is an operational example 800 of a user interface display that supports providing transportation corridor recommendations in accordance with at least some embodiments of the present disclosure. In accordance with the operational example 800, the user interface display may a visual representation of a weather event, such as an emergency weather event. In such examples, if a current transportation corridor 805 utilized by a vehicle is routed through or within a threshold distance of the weather event, a recommended transportation corridor 810 may be provided. The recommended transportation corridor 810 may route the vehicle around or a threshold distance away from a center of the weather event.

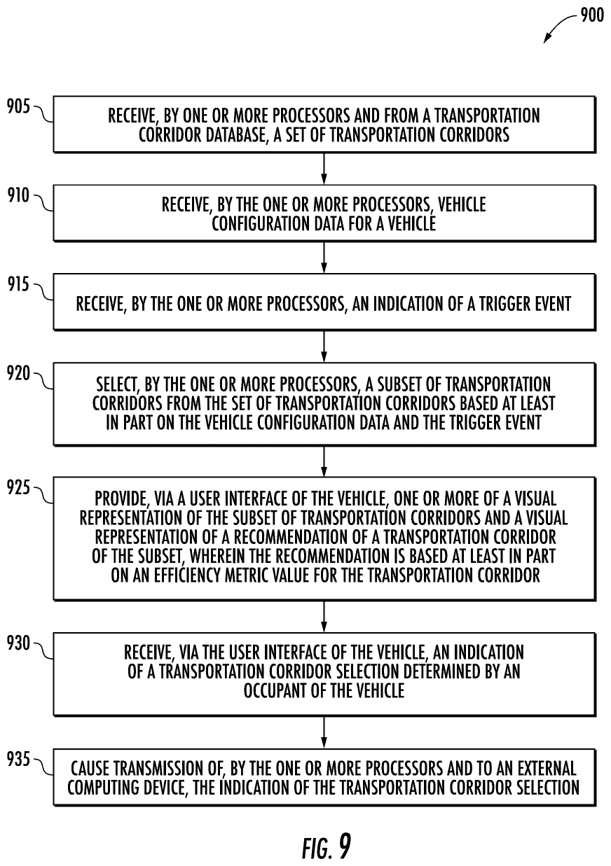

FIG. 9 illustrates a process 900 for providing transportation corridor recommendations in accordance with at least some embodiments of the present disclosure. Specifically, FIG. 9 depicts operations of an example process 900. In some embodiments, the process 900 is embodied by computer program code stored on a non-transitory computer-readable storage medium of a computer program product configured for execution to perform the process as depicted and described. Additionally, or alternatively, in some embodiments, the process 900 is performed by at least one specifically configured computing device, such as at least one computing device 200 alone or in communication with at least one other component, device, system, and/or the like. In this regard, in some such embodiments, the computing device 200 is specially configured by computer-coded instructions (e.g., computer program instructions) stored thereon, for example in the memory 204 and/or another component depicted and/or described herein and/or otherwise accessible to the computing device 200, for performing the operations as depicted and described. In some embodiments, the computing device 200 is in communication with at least one external apparatus, system, device, and/or the like, to perform at least one of the operations as depicted and described. For example, the computing device 200, in some embodiments, is in communication with an external computing device, a client device, and/or the like. For purposes of simplifying the description, the process 900 is described as performed by and from the perspective of the computing device 200.

The process 900 begins at operation 905. At operation 905, the computing device 200 includes means such as the sensors 210, navigation circuitry 212, flight operations circuitry 214, virtual management circuitry 216, communications circuitry 208, input/output circuitry 206, and/or processor 202, or a combination thereof, to receive, by one or more processors and from a transportation corridor database, a set of transportation corridors.

At operation 910, the computing device 200 includes means such as the sensors 210, navigation circuitry 212, flight operations circuitry 214, virtual management circuitry 216, communications circuitry 208, input/output circuitry 206, and/or processor 202, or a combination thereof, to receive, by the one or more processors, vehicle configuration data for a vehicle.

At operation 915, the computing device 200 includes means such as the sensors 210, navigation circuitry 212, flight operations circuitry 214, virtual management circuitry 216, communications circuitry 208, input/output circuitry 206, and/or processor 202, or a combination thereof, to receive, by the one or more processors, an indication of a trigger event.

At operation 920, the computing device 200 includes means such as the sensors 210, navigation circuitry 212, flight operations circuitry 214, virtual management circuitry 216, communications circuitry 208, input/output circuitry 206, and/or processor 202, or a combination thereof, to select, by the one or more processors, a subset of transportation corridors from the set of transportation corridors based at least in part on (i) the vehicle configuration data and (ii) the trigger event.

At operation 925, the computing device 200 includes means such as the sensors 210, navigation circuitry 212, flight operations circuitry 214, virtual management circuitry 216, communications circuitry 208, input/output circuitry 206, and/or processor 202, or a combination thereof, to provide, via a user interface of the vehicle, one or more of: (a) a visual representation of the subset of transportation corridors and (b) a visual representation of a recommendation of a transportation corridor of the subset, wherein the recommendation is based at least in part on an efficiency metric value for the transportation corridor.

At operation 930, the computing device 200 includes means such as the sensors 210, navigation circuitry 212, flight operations circuitry 214, virtual management circuitry 216, communications circuitry 208, input/output circuitry 206, and/or processor 202, or a combination thereof, to receive, via the user interface of the vehicle, an indication of a transportation corridor selection determined by an occupant of the vehicle.

At operation 935, the computing device 200 includes means such as the sensors 210, navigation circuitry 212, flight operations circuitry 214, virtual management circuitry 216, communications circuitry 208, input/output circuitry 206, and/or processor 202, or a combination thereof, to cause transmission of, by the one or more processors and to an external computing device, the indication of the transportation corridor selection.

### CONCLUSION

Many modifications and other embodiments of the disclosure set forth herein will come to mind to one skilled in the art to which this disclosure pertains having the benefit of the teachings presented in the foregoing description and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

In some embodiments, some of the operations above may be modified or further amplified. Furthermore, in some embodiments, additional optional operations may be included. Modifications, amplifications, or additions to the operations above may be performed in any order and in any combination.

Although an example processing system has been described above, implementations of the subject matter and the functional operations described herein can be implemented in other types of digital electronic circuitry, or in computer software, firmware, or hardware, including the structures disclosed in this specification and their structural equivalents, or in various combinations.

Embodiments of the subject matter and the operations described herein can be implemented in digital electronic circuitry, or in computer software, firmware, or hardware, including the structures disclosed in this specification and their structural equivalents, or in various combinations. Embodiments of the subject matter described herein can be implemented as at least one computer program, i.e., at least one module of computer program instructions, encoded on computer storage medium for execution by, or to control the operation of, information/data processing apparatus. Alternatively, or in addition, the program instructions can be encoded on an artificially generated, propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination. Moreover, while a computer storage medium is not a propagated signal, a computer storage medium can be a source or destination of computer program instructions encoded in an artificially generated, propagated signal. The computer storage medium can also be, or be included in, at least one separate physical component or media (e.g., multiple CDs, disks, or other storage devices).

The operations described herein can be implemented as operations performed by an information/data processing apparatus on information/data stored on at least one computer-readable storage device or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or any combination thereof. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., at least one script stored in a markup language document), in a single file dedicated to the program in question, or in multiple coordinated files (e.g., files that store at least one module, sub-program, or portion of code). A computer program can be deployed to be executed on one computer or on multiple computers that are located at one site or distributed across multiple sites and interconnected by a communication network.

The processes and logic flows described herein can be performed by at least one programmable processor executing at least one computer program to perform actions by operating on input information/data and generating output. Processors suitable for the execution of a computer program include, by way of example, both general and special purpose microprocessors, and any processor of any kind of digital computer. Generally, a processor will receive instructions and information/data from a read-only memory or a random access memory or both. The essential elements of a computer are a processor for performing actions in accordance with instructions and at least one memory device for storing instructions and data. Generally, a computer will also include, or be operatively coupled to receive information/data from or transfer information/data to, or both, at least one mass storage device for storing data, e.g., magnetic, magneto-optical disks, or optical disks.

However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of at least one such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, at least one feature from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
receiving, by one or more processors and from a transportation corridor database, a set of transportation corridors;
receiving, by the one or more processors, vehicle configuration data for a vehicle;
receiving, by the one or more processors, an indication of a trigger event;
selecting, by the one or more processors, a subset of transportation corridors from the set of transportation corridors based at least in part on (i) the vehicle configuration data and (ii) the trigger event;
providing, via a user interface of the vehicle, one or more of: (a) a visual representation of the subset of transportation corridors and (b) a visual representation of a recommendation of a transportation corridor of the subset, wherein the recommendation is based at least in part on an efficiency metric value for the transportation corridor;
receiving, via the user interface of the vehicle, an indication of a transportation corridor selection determined by an occupant of the vehicle; and
causing transmission of, by the one or more processors and to an external computing device, the indication of the transportation corridor selection.

2. The method of claim 1, further comprising:
receiving, by the one or more processors, a signal indicative of a request from the occupant of the vehicle for the efficiency metric value; and
providing, via the user interface of the vehicle, an indication of the efficiency metric value based at least in part on receiving the signal.

3. The method of claim 2, wherein the signal is generated based at least in part on the occupant of the vehicle positioning a cursor over a visual representation of the transportation corridor of the subset.

4. The method of claim 1, further comprising:
providing, via the user interface of the vehicle, (i) the indication of the efficiency metric value for the transportation corridor and (ii) a second indication of a second efficiency metric value for a second transportation corridor of the subset of transportation corridors, wherein the transportation corridor selection is based at least in part on the occupant of the vehicle comparing the efficiency metric value and the second efficiency metric value.

5. The method of claim 4, wherein the transportation corridor selection indicates that the occupant of the vehicle has selected the second transportation corridor.

6. The method of claim 1, wherein the transportation corridor selection indicates that the occupant of the vehicle has selected the transportation corridor.

7. The method of claim 1, wherein the vehicle configuration data comprises one or more of: (i) vehicle size data, (ii) vehicle weight data, (iii) vehicle capability data, (iv) vehicle navigational data, and (v) vehicle type data.

8. The method of claim 1, wherein the trigger event comprises receiving one or more of: (i) weather data, (ii) traffic data, (iii) flight management system (FMS) data, and (iv) vehicle status data.

9. The method of claim 1, wherein the set of transportation corridors comprises a plurality of transportation corridors below a threshold altitude.

10. The method of claim 1, wherein the set of transportation corridors comprises a plurality of transportation corridors for vertical takeoff and landing (VTOL) vehicles.

11. The method of claim 1, further comprising:
communicating one or more control signals to one or more control systems of the vehicle based at least in part on the transportation corridor selection, wherein the one or more control signals cause the vehicle to switch from an initial transportation corridor to a selected transportation corridor.

12. A system comprising:
a user interface; and
one or more processors in communication with the user interface, the one or more processors configured to:
receive, from a transportation corridor database, a set of transportation corridors;
receive vehicle configuration data for a vehicle;
receive an indication of a trigger event;
select a subset of transportation corridors from the set of transportation corridors based at least in part on (i) the vehicle configuration data and (ii) the trigger event, wherein the user interface is configured to display one or more of: (a) a visual representation of the subset of transportation corridors and (b) a visual representation of a recommendation of a transportation corridor of the subset, the recommendation based at least in part on an efficiency metric value for the transportation corridor;
receive, via the user interface of the vehicle, an indication of a transportation corridor selection determined by an occupant of the vehicle; and
cause transmission of, to an external computing device, the indication of the transportation corridor selection.

13. The system of claim 12, wherein the one or more processors are further configured to:
receive a signal indicative of a request from the occupant of the vehicle for the efficiency metric value, wherein the user interface is configured to display an indication of the efficiency metric value based at least in part on receiving the signal.

14. The system of claim 13, wherein the signal is generated based at least in part on the occupant of the vehicle positioning a cursor over a visual representation of the transportation corridor of the subset.

15. The system of claim 12, wherein the user interface is further configured to:
display (i) an indication of the efficiency metric value for the transportation corridor and (ii) a second indication of a second efficiency metric value for a second transportation corridor of the subset of transportation corridors, wherein the transportation corridor selection is based at least in part on the occupant of the vehicle comparing the efficiency metric value and the second efficiency metric value.

16. The system of claim 15, wherein the transportation corridor selection indicates that the occupant of the vehicle has selected the second transportation corridor.

17. The system of claim 12, wherein the transportation corridor selection indicates that the occupant of the vehicle has selected the transportation corridor.

18. The system of claim 12, wherein the vehicle configuration data comprises one or more of: (i) vehicle size data, (ii) vehicle weight data, (iii) vehicle capability data, (iv) vehicle navigational data, and (v) vehicle type data.

19. The system of claim 12, wherein the trigger event comprises receiving one or more of: (i) weather data, (ii) traffic data, (iii) flight management system (FMS) data, and (iv) vehicle status data.

20. An apparatus comprising:
one or more processors; and
a memory storing instructions that, when executed by the one or more processors, cause the apparatus to:
receive, by the one or more processors and from a transportation corridor database, a set of transportation corridors;
receive, by the one or more processors, vehicle configuration data for a vehicle;
receive, by the one or more processors, an indication of a trigger event;
select, by the one or more processors, a subset of transportation corridors from the set of transportation corridors based at least in part on (i) the vehicle configuration data and (ii) the trigger event;
provide, via a user interface of the vehicle, one or more of: (a) a visual representation of the subset of transportation corridors and (b) a visual representation of a recommendation of a transportation corridor of the subset, wherein the recommendation is based at least in part on an efficiency metric value for the transportation corridor,
receive, via the user interface of the vehicle, an indication of a transportation corridor selection determined by an occupant of the vehicle; and
cause transmission of, by the one or more processors and to an external computing device, the indication of the transportation corridor selection.
